(19) United States
(12) Patent Application Publication
(10) Pub. No.: US 2014/0374300 A1
(43) Pub. Date: Dec. 25, 2014

(54) Wacky Eaters

(71) Applicant: Adan Espinosa, Galveston, TX (US)

(72) Inventor: Adan Espinosa, Galveston, TX (US)

(21) Appl. No.: 14/313,219

(22) Filed: Jun. 24, 2014

Related U.S. Application Data
(60) Provisional application No. 61/838,900, filed on Jun. 25, 2013.

(51) Int. Cl. B65F 1/14

(52) U.S. Cl. CPC B65F 1/163; B65F 1/14; B65F 2001/1653
USPC 206/457; 220/212; 220/263

(57) ABSTRACT

A trash receptacle device is disclosed that is a trash or storage bin, and that resembles an animal and makes noises to attract and entertain children. The trash receptacle device comprises a housing component with a hollow cavity, a removable trash receptacle component that is inserted into the hollow cavity, and a hinged lid secured to the housing component. Typically, the housing component is shaped to resemble an animal, and the hinged lid is shaped to resemble an animal head. The hinged lid can be controlled by a step pedal component, which can be shaped to resemble a paw or foot of an animal. Additionally, the trash receptacle device can comprise a sound box component and at least one speaker in communication with the hinged lid, such that the sound box component plays a recording of an animal sound when the hinged lid is opened.

### CROSS-REFERENCE

This application claims priority from Provisional Patent Application Ser. No. 61/838,900 filed Jun. 25, 2013.

### BACKGROUND

Generally, trash bins are often too large to be concealed within a room, or a user may find it inconvenient to hide the receptacle. Additionally, children may have trouble getting in the habit of throwing away trash, putting away toys and generally keeping an area tidy. An effective solution is necessary.

The present invention provides a trash receptacle that resembles an animal, and eliminates the problem of an unsightly trash bin standing out in a room. The device functions as a storage bin for toys and other items as well, and encourages children to throw away their trash or put away their toys. Additionally, the device plays an animal sound when opened if desired. This trash receptacle device benefits children, as well as adults.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a trash receptacle device that is a trash or storage bin, and that resembles an animal and makes noises to attract and entertain children. The trash receptacle device comprises a housing component with a hollow cavity, a removable trash receptacle component that is inserted into the hollow cavity, and a hinged lid secured to the housing component. Typically, the housing component is shaped to resemble an animal, and the hinged lid is shaped to resemble an animal head. The animal can be any one of, but not limited to, a dog, a cat, a lion, a monkey, a tiger, a penguin, a bear, a pig, or a cow. Furthermore, the removable trash receptacle component is designed to accommodate a standard trash bag, or can be utilized as a storage container for toys or other items, depending on the needs and wants of a user.

In a preferred embodiment, the hinged lid can be controlled by a step pedal component, which can be shaped to resemble a paw or foot of an animal. Additionally, the trash receptacle device can comprise a sound box component and at least one speaker in communication with the hinged lid, such that the sound box component plays a recording of an animal sound when the hinged lid is opened. Typically, the speaker is positioned in an ear portion of the housing component, but can be positioned in any suitable place on the housing component as is known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the trash receptacle device in accordance with the disclosed architecture.

FIG. 2 illustrates a perspective view of the trash receptacle device with the removable trash receptacle component being inserted into the housing in accordance with the disclosed architecture.

FIG. 3 illustrates a perspective view of the trash receptacle device in a child's room in accordance with the disclosed architecture.

FIG. 4 illustrates a perspective view of the trash receptacle device in a child's playroom in accordance with the disclosed architecture.

FIG. 5 illustrates a perspective view of the trash receptacle device in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention provides a trash receptacle that resembles an animal, and eliminates the problem of an unsightly trash bin standing out in a room. The device functions as a storage bin for toys and other items as well, and encourages children to throw away their trash or put away their toys. Additionally, the device plays an animal sound when opened if desired. Thus, this trash receptacle device benefits children, as well as adults.

The trash receptacle device comprises a housing component with a hollow cavity, a removable trash receptacle component that is inserted into the hollow cavity, and a hinged lid secured to the housing component. Typically, the housing component is shaped to resemble an animal, and the hinged lid is shaped to resemble an animal head. The hinged lid can be controlled by a step pedal component, which can be shaped to resemble a paw or foot of an animal. Additionally, the trash receptacle device can comprise a sound box component and at least one speaker in communication with the hinged lid, such that the sound box component plays a recording of an animal sound when the hinged lid is opened.

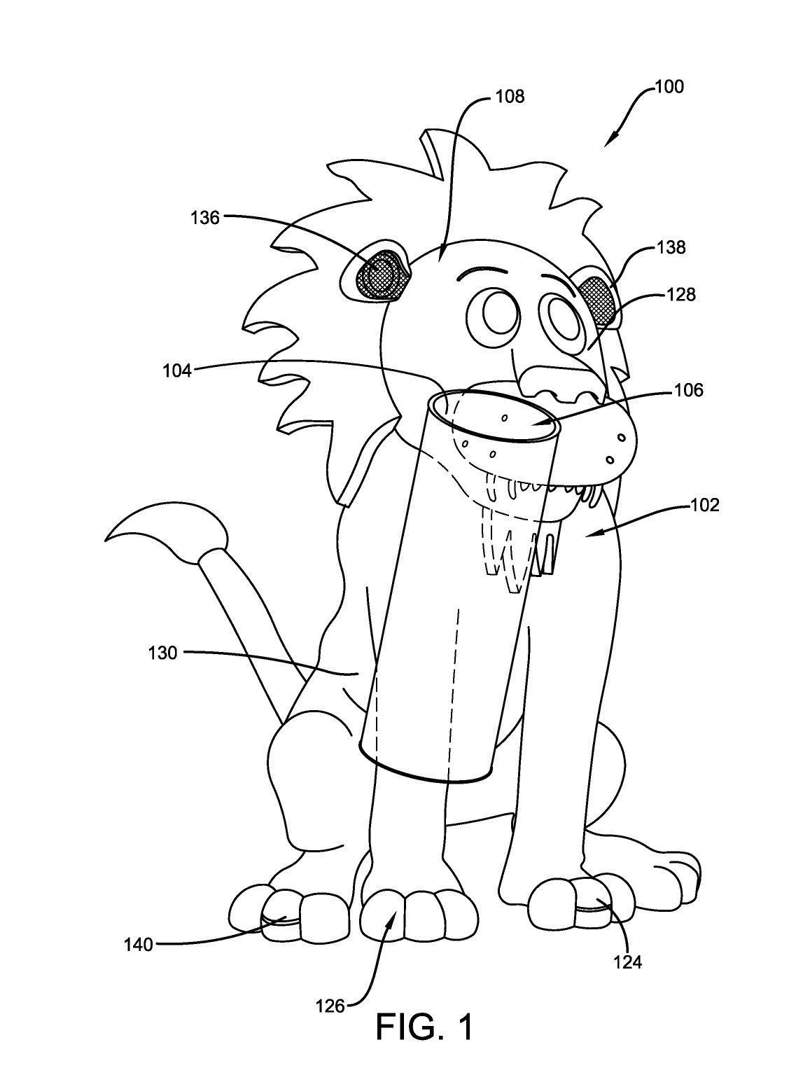

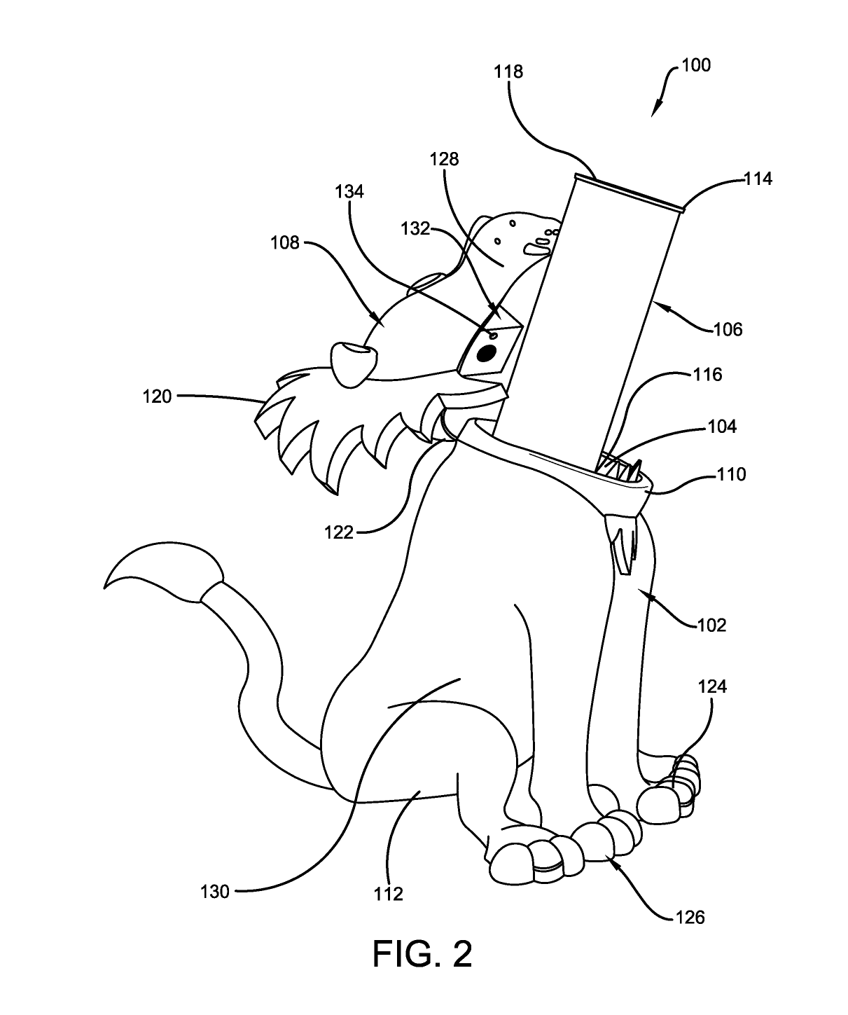

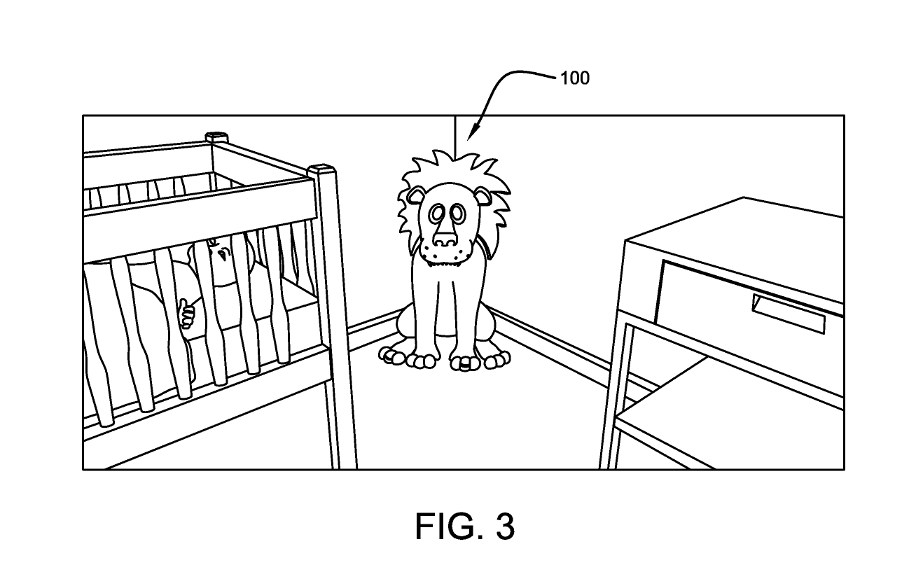

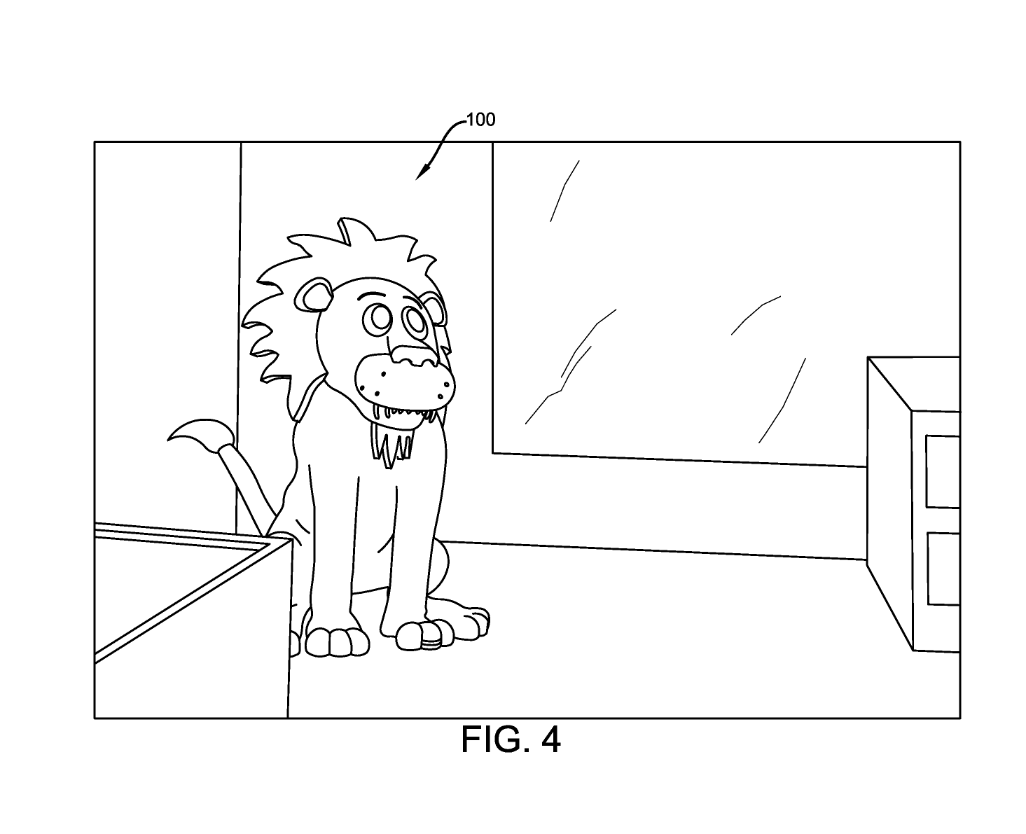

Referring initially to the drawings, FIGS. 1-4 illustrate the trash receptacle device 100 that is a trash or storage bin, and that resembles an animal and makes noises to attract and entertain children. The trash receptacle device 100 comprises a housing component 102 with a hollow cavity 104, a removable trash receptacle component 106 that is inserted into the hollow cavity 104, and a hinged lid 108 secured to the housing component 102 (as shown in FIG. 2).

The housing component 102 comprises a first end 110, a second end 112, and a hollow cavity 104 defined therebetween. Typically, the housing component 102 is shaped to resemble an animal, but can be any suitable shape as is known in the art, without affecting the overall concept of the invention. The animal can be any one of, but not limited to, a dog, a cat, a lion, a monkey, a tiger, a penguin, a bear, a pig, or a cow. The housing component 102 would generally be constructed of plastic, such as ABS or PVC, though any other suitable material may be used to manufacture the housing component 102 as is known in the art without affecting the overall concept of the invention. The housing component 102 can also comprise a variety of colors and designs to suit user and manufacturing preference, and the shape and size of the housing component 102 may vary greatly depending on the wants and needs of a user.

Furthermore, the housing component 102 comprises a hollow cavity 104 which is shaped to receive or accommodate a removable trash receptacle component 106. Typically, the removable trash receptacle component 106 is cylindrical in shape with a hollow cavity 118 therein, but can be any suitable shape as is known in the art, such as a rectangular prism, etc., without affecting the overall concept of the invention. The removable trash receptacle component 106 would generally be constructed of plastic, such as ABS or PVC, though any other suitable material may be used to manufacture the removable trash receptacle component 106 as is known in the art without affecting the overall concept of the invention. Typically, the removable trash receptacle component 106 is inserted and slid into the hollow cavity 104, and can also be removed by being slid out of the hollow cavity 104.

The hollow cavity 118 of the removable trash receptacle component 106 is designed to accommodate a standard trash bag (not shown). The removable trash receptacle component 106 can be designed in multiple sizes to accommodate multiple sizes of trash bags, such as 4 gallon, 10 gallon, or other common-sized trash bags. The removable trash receptacle component 106 can also comprise a variety of colors and designs to suit user and manufacturing preference, and the shape and size of the removable trash receptacle component 106 may vary greatly depending on the wants and needs of a user.

Additionally, the removable trash receptacle component 106 does not have to hold trash, and can be utilized as a storage container for toys or other items, depending on the needs and wants of a user.

Furthermore, the housing component 102 comprises a hinged lid 108 secured to the first end 110. The hinged lid 108 can be secured via any suitable securing means such as a hinge, a fastener, etc., as long as the lid 108 can open and close. Typically, the hinged lid 108 is shaped to resemble an animal head 128, but can be any suitable shape as is known in the art, without affecting the overall concept of the invention. The animal head can be any one of, but not limited to, a dog, a cat, a lion, a monkey, a tiger, a penguin, a bear, a pig, or a cow. Generally, the housing component 102 is shaped as the animal body 130 and the hinged lid 108 is shaped as the animal head 128. The hinged lid 108 is typically constructed of the same material as the housing component 102 which is plastic, such as ABS or PVC, though any other suitable material may be used to manufacture the hinged lid 108 as is known in the art without affecting the overall concept of the invention. The hinged lid 108 can also comprise a variety of colors and designs to suit user and manufacturing preference, and the shape and size of the hinged lid 108 may vary greatly depending on the wants and needs of a user.

Furthermore, the hinged lid 108 can be controlled by a step pedal component 124. The step pedal component 124 can be any suitable step pedal as is known in the art and is in mechanical communication with the housing component 102 and the hinged lid 108, such that stepping on the step pedal component 124 raises the hinged lid 108. Further, the step pedal component 124 can be shaped to resemble a paw or foot 126 of an animal.

Additionally, the trash receptacle device 100 can comprise a sound box component 132 in communication with the hinged lid 108, such that the sound box component 132 plays a recording of an animal sound when the hinged lid 108 is opened. The sound box component 132 can be any suitable sound box as is known in the art, as long as it functions to emit a sound when activated. Typically, the trash receptacle device 100 also includes a power switch 134 in electrical communication with the sound box component 132 that turns on and off the sound box component 132. The power switch 134 can be located on any suitable position of the trash receptacle device 100 depending on the wants and needs of a user and on manufacturing preferences.

Furthermore, the trash receptacle device 100 can comprise at least one speaker 136 in electrical communication with the sound box component 132. Any suitable number of speakers can be used as is known in the art. Typically, the speaker 136 is positioned in an ear portion 138 of the housing component 102, but can be positioned in any suitable place on the housing component 102 as is known in the art. Additionally, the speaker 136 can comprise a power switch 140 for activating the speaker 136. The speaker power switch 140 can be positioned anywhere on the trash receptacle device 100, but is typically positioned in an animal's foot or paw 126. If positioned in the foot or paw 126, the speaker power switch 140 is typically located in a different foot or paw, than where the step pedal component 124 is located.

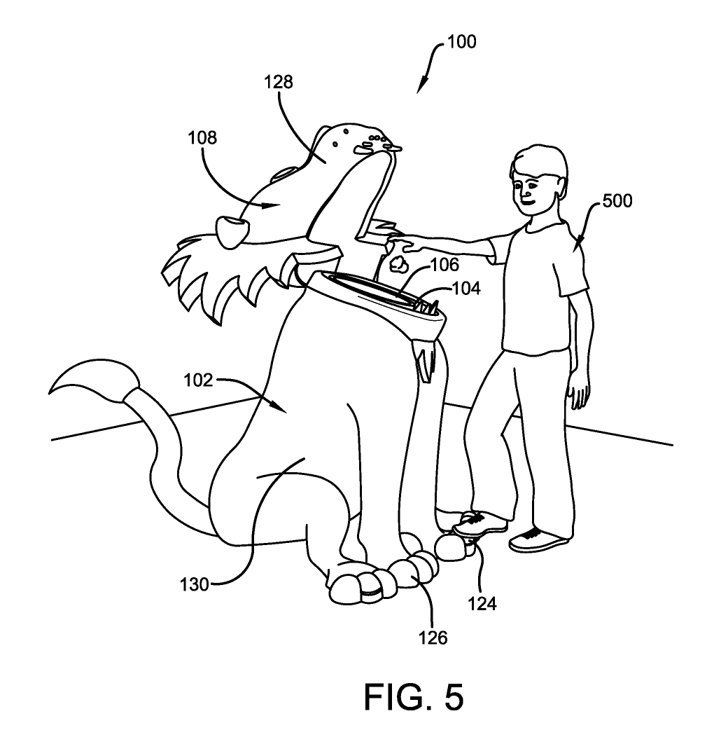

FIG. 5 illustrates the trash receptacle device 100 in use. As stated supra, the trash receptacle device 100 comprises a housing component 102 with a hollow cavity 104, a removable trash receptacle component 106 that is inserted into the hollow cavity 104, and a hinged lid 108 secured to the housing component 102. Typically, the housing component 102 is shaped to resemble an animal 130, and the hinged lid 108 is shaped to resemble an animal head 128.

The hinged lid 108 can be controlled by a step pedal component 124, which can be shaped to resemble a paw or foot 126 of an animal. Additionally, the trash receptacle device 100 can comprise a sound box component 132 and at least one speaker 136 in communication with the hinged lid 108, such that the sound box component 132 plays a recording of an animal sound when the hinged lid 108 is opened.

In operation, a user 500 would choose the size and/or specific color, as well as specific type of animal for the trash receptacle device 100 that meets their needs and/or wants. The user 500 would then choose whether to use the trash receptacle device 100 as a trash receptacle or as a storage unit for toys and other items. If used as a storage receptacle, the trash receptacle device 100 can be placed in the child's room or other room and filled with toys or other items for storage.

If used as a trash receptacle, the user 500 would remove the removable trash receptacle component 106 from the housing component 102 and would place a standard trash bag (not shown) in the removable trash receptacle component 106. The user 500 would then slide the removable trash receptacle component 106 back into the housing component 102. Once inserted, the trash receptacle device 100 can be placed in a child's room or other room and used like a standard trash can.

Specifically, the user 500 would step on the paw or foot 126 of the animal to raise the hinged lid 108. Raising the hinged lid 108 would also activate the sound box component 132, which would play a recording of the animal's sound. The power switch 134 can then be used to turn on and off the sound box component 132, depending on the wants and needs of a user 500. Thus, the device eliminates the problem of an unsightly trash bin standing out in a room, and encourages children to throw away their trash or put away their toys.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trash receptacle device, comprising:
a housing component comprising a first end, a second end, and a hollow cavity defined therebetween;
a removable trash receptacle component that is inserted into the hollow cavity; and
a hinged lid secured to the first end of the housing component.

2. The trash receptacle device of claim 1, wherein the housing component is shaped to resemble an animal.

3. The trash receptacle device of claim 2, wherein the hinged lid is shaped to resemble an animal's head.

4. The trash receptacle device of claim 3, wherein the animal can be any one of a dog, a cat, a lion, a monkey, a tiger, a penguin, a bear, a pig, or a cow.

5. The trash receptacle device of claim 1, further comprising a step pedal component in mechanical communication with the housing component and the hinged lid, such that stepping on the step pedal component raises the hinged lid.

6. The trash receptacle device of claim 5, wherein the step pedal component is shaped to resemble a paw or foot of an animal.

7. The trash receptacle device of claim 1, further comprising a sound box component in communication with the hinged lid, such that the sound box component plays a recording of an animal sound when the hinged lid is opened.

8. The trash receptacle device of claim 7, further comprising a power switch in electrical communication with the sound box component that turns on and off the sound box component.

9. The trash receptacle device of claim 8, further comprising at least one speaker in electrical communication with the sound box component.

10. The trash receptacle device of claim 9, wherein the at least one speaker is positioned in an ear portion of the housing component.

11. The trash receptacle device of claim 10, further comprising a power switch for activating the at least one speaker positioned in an animal's foot or paw.

12. A trash receptacle device, comprising:
a housing component shaped to resemble an animal body and comprising a first end, a second end, and a hollow cavity defined therebetween;
a removable trash receptacle component that is inserted into the hollow cavity; and
a hinged lid shaped to resemble an animal head and secured to the first end of the housing component.

13. The trash receptacle device of claim 12, wherein the animal can be any one of a dog, a cat, a lion, a monkey, a tiger, a penguin, a bear, a pig, or a cow.

14. The trash receptacle device of claim 12, further comprising a step pedal component in mechanical communication with the housing component and the hinged lid, such that stepping on the step pedal component raises the hinged lid.

15. The trash receptacle device of claim 14, wherein the step pedal component is shaped to resemble a paw or foot of an animal.

16. The trash receptacle device of claim 14, further comprising a sound box component in communication with the hinged lid, such that the sound box component plays a recording of an animal sound when the hinged lid is opened.

17. The trash receptacle device of claim 16, further comprising a power switch in electrical communication with the sound box component that turns on and off the sound box component.

18. The trash receptacle device of claim 17, further comprising at least one speaker in electrical communication with the sound box component and positioned in an ear portion of the housing component.

19. A trash receptacle device, comprising:
a housing component shaped to resemble an animal body and comprising a first end, a second end, and a hollow cavity defined therebetween;
a removable trash receptacle component that is inserted into the hollow cavity; and
a hinged lid shaped to resemble an animal head and secured to the first end of the housing component;
a step pedal component shaped to resemble an animal paw or foot and in mechanical communication with the removable trash receptacle component and the hinged lid, such that stepping on the step pedal component raises the hinged lid; and
a sound box component in communication with the hinged lid, such that the sound box component plays a recording of an animal sound when the hinged lid is opened.

20. The trash receptacle device of claim 19, further comprising at least one speaker in electrical communication with the sound box component and positioned in an ear portion of the housing component.
